(19) United States
(12) Patent Application Publication
(10) Pub. No.: US 2011/0275747 A1
(43) Pub. Date: Nov. 10, 2011

(54) STABILIZER SYSTEMS FOR POLYMERS CONTAINING HALOGEN

(76) Inventors: Peter Hacker, Munchen (DE); Reinhard Beck, Leipzig (DE)

(21) Appl. No.: 12/774,934

(22) Filed: May 6, 2010

(51) Int. Cl. C08K 5/17; C08K 5/21; C09K 3/00

(52) U.S. Cl. 524/211; 252/380; 524/186

(57) ABSTRACT

The present invention relates to a stabilizer system for polymers containing halogen, comprising an alkaline earth metal double carbonate of the formula (A)

(M¹O)_{m*}(M²O)_{n-m*}(CO₂)_{o*}(H₂O)ₚ (A)
where
M¹ and M²=various alkaline earth metals;
m=from 0.9 to 1.1;
n=from 1.9 to 2.1 and p=from 0 to 2.1; or n=from 3.9 to 4.1, and p=from 0 to 4.1;
o=from 0 to 1.1
   and at least one of the compounds selected from the group consisting of (B) and (C), where
(B) is at least one nitrogen-containing organic compound selected from the group consisting of (B1) and (B2), where (B1) is a tert-alkanolamine and (B2) is an enaminone or a urea, and
(C) is an alkaline earth metal aluminohydroxocarbonate of the formula (C)

(M₁₋ₓZnₓ)_{y}Al₂(OH)_{4+2y}CO_{3*}zH₂O (C)
where M=magnesium or/and calcium; x=from 0 to 0.5; y=from 2 to 8, and z=from 0 to 12.

The present invention further relates to compositions and articles comprising said stabilizer systems, and to processes for stabilizing a polymer containing halogen.

The present invention relates to stabilizer systems for polymers containing halogen, and also to compositions and articles comprising the stabilizer systems, and to processes for stabilizing a polymer containing halogen.

It is known that halogen-containing plastics have a tendency toward undesired decomposition reactions and undesired degradation reactions when they are subjected to thermal stress during processing or in long-term use. This problem can be solved by using metal-containing stabilizers, these being added to the polymers containing halogen prior to or during processing. Among the known stabilizers are barium-cadmium stabilizers, lead stabilizers, organotin stabilizers, and barium-zinc stabilizers. However, all of these groups of stabilizers contain heavy metals or comprise toxic metals, and this is disadvantageous for the environmental compatibility of the materials.

For these reasons, recent years have seen increasing development of systems known as organic systems, which are free from heavy metals, and these are now also available in the market. They are solid stabilizers and are mostly handled in a compacted, more environmentally friendly form. These organically based systems are multicomponent mixtures, the main component of which is mostly a member of the hydrotalcites group (magnesium aluminum hydroxycarbonates).

Heavy-metal-free hydrotalcite and, respectively, hydrocalumite (katoite) compositions which function as heat stabilizers for PVC are described by way of example in EP 1 046 668 B1 and EP 0930 332 B1.

However, these classes of compound are relatively expensive and are subject to restrictions in use, since the naturally occurring forms are either not available in sufficient quantity or have heavy-metal-containing impurities, mainly iron carbonates and manganese carbonates. These impurities drastically reduce stabilizer effect in PVC.

Synthetic processes therefore have to be adopted to permit wider access to these classes of substance. However, industrial-scale production is expensive, because of the raw materials involved. The production process is also hindered by considerable amounts of waste water, because of the magnesium salts, calcium salts, and aluminum salts that have to be used. This is a fact that cannot be ignored in large-scale industrial synthesis processes. It is therefore necessary to search for substances which are less expensive. These should, as far as possible, be accessible in an environmentally compatible manner, without excessive use of resources.

This objective has been achieved to some extent in recent years by the availability of chemically modified dolomites by a calcining process, since dolomites per se do not function as stabilizers. Access to these compounds is based on semisynthetic processes, since naturally occurring minerals can be used as starting materials. These minerals (dolomites) are available in enormous quantities and often with a purity that does not require any further purification process with attendant waste-water problems. Various additives have been used to improve the quality levels of product and of performance.

Relevant publications are found in EP-A 0 422 335 and EP-A 0 945 483. US-A 2006/188428 discloses a semisynthetic production process.

However, most of the stabilizer combinations available hitherto and comprising calcined dolomites still have heavy metal content, or excessive heavy metal content, or do not have entirely satisfactory performance.

There continues to be a requirement, therefore, for alternative stabilizer systems that are inexpensive and highly effective.

It is therefore an object of the present invention to provide stabilizer systems of that type.

The object is achieved via a stabilizer system for polymers containing halogen, comprising

an alkaline earth metal double carbonate of the formula (A)

(M¹O)_{m*}(M²O)_{n-m*}(CO₂)_{o*}(H₂O)ₚ (A)
where
M¹ and M²=various alkaline earth metals;
m=from 0.9 to 1.1;
n=from 1.9 to 2.1 and p=from 0 to 2.1; or n=from 3.9 to 4.1, and p=from 0 to 4.1;
o=from 0 to 1.1
   and at least one of the compounds selected from the group consisting of (B) and (C), where
(B) is at least one nitrogen-containing organic compound selected from the group consisting of (B1) and (B2), where (B1) is a tert-alkanolamine and (B2) is an enaminone or a urea, and
(C) is an alkaline earth metal aluminohydroxocarbonate of the formula (C)

(M₁₋ₓZnₓ)_{y}Al₂(OH)_{4+2y}CO_{3*}zH₂O (C)
where M=magnesium or/and calcium; x=from 0 to 0.5; y=from 2 to 8, and z=from 0 to 12.

The systems of the invention serve to stabilize a polymer containing halogen, preference being given to a chlorine-containing polymer, in particular PVC.

The alkaline earth metal double carbonates of the formula (A) are preferably dolomites or huntites that can be obtained from naturally occurring or synthetic dolomites or huntites, preference being given to the naturally occurring material.

The present invention therefore preferably provides a stabilizer system of the invention where the alkaline earth metal double carbonate (A) is a calcined huntite of the formula (A1)

(CaO)_{m*}(MgO)_{n-m*}(CO₂)ₒ (A1)

where m=from 0.9 to 1.1; n=from 3.9 to 4.1, and o=from 0 to 1.1.

The present invention also preferably provides a stabilizer system of the invention where the alkaline earth metal double carbonate (A) is a calcined dolomite of the formula (A2)

(CaO)_{m*}(MgO)_{n-m*}(CO₂)ₒ (A2)

where m=from 0.9 to 1.1; n=from 1.9 to 2.1, and o=from 0 to 1.1.

The materials are obtained via calcining at from 550 to 1200° C. The calcining times are preferably from 10 to 20 hours. The calcined material can then be reacted with water to give the slaked material, and this slaking process can be a partial or complete process. The temperatures for the wet treatment process are preferably from 60 to 95° C., the reaction times being from 40 to 100 hours. The calcining can take place in two stages.

Stage 1: Complete calcining to magnesium oxide, producing calcium magnesium oxide carbonate constituted as follows:

MgO_{*}CaCO₃ (A4)

(CAS No.: 83897-84-1). The use of this substance is preferred.

This semicalcined dolomite is also termed magnomass or akdolite. It comprises a highly reactive magnesium oxide (Ullmann's Enzyklopädie der technischen Chemie [Ullmann's Encyclopedia of Industrial Chemistry], Verlag Schwarzenberg/Minden-Berlin, 3rd edn. (1960), vol. 12, p. 125).

Slaking with water gives hydromagnocalcite:

Mg(OH)_{2*}CaCO₃

which can also be used with preference.

Stage 2: Partial or complete calcining to calcium oxide. Very particular preference is given to the use of the substance constituted as follows:

CaMgO₂ (A3)

(CAS No.: 37247-91-9) which is produced via complete calcining to calcium magnesium dioxide (double oxide).

This substance has a metastable crystal lattice, since the regular arrangement of the resultant microcrystals of calcium oxide and magnesium oxide causes mutual hindrance of crystal growth (Ullmann's Encyclopaedia of Ind. Chem., Verlag-Chemie, Weinheim, 5th edn., vol. 15, p. 611).

The materials obtained are gray or white, as a function of admixtures (impurities in the ores). Partial slaking can then be carried out until a crumbly mass is produced. At the end of the process, the solids are milled to give a fine powder, which can be coated with fatty acids, preferably palmitic or stearic acid.

Coated compounds are in principle preferred. Production of these is known in the prior art. By way of example, coatings are also produced in EP-A 0 422 335.

The present application also preferably provides a stabilizer system of the invention in which at least one compound (A), (A1), (A2), (A3) and (A4) is present in coated form.

The crystal lattice of dolomite and huntite differs from the crystal lattice of calcite (calcium carbonate) and of magnesite (magnesium carbonate) in that the double carbonate dolomite has alternating layers of CaO₆ and MgO₆ octahedrons with intercalated carbonate anions, and the structure of the calcined material (CaMgO₂) is therefore not the same as that of calcium oxide (CaO) and magnesium oxide (MgO), both of which crystallize with a sodium chloride lattice. The calcining process therefore results in altered structures having alternating planes of calcium oxide and of magnesium oxide.

The crystal lattice of huntite is relatively complicated, since there are CaO₆ octahedra and CaO₆ trigonal prisms present here as well as MgO₆ octahedra (see dolomite and huntite crystal structures in: Mineral Structure Data Base, University of Colorado; Dollase W. A., Am. Mineral. 71, 163 [1986]). The lattice positions of the calcium and magnesium ions are retained during the calcining process, and the structure of this calcined material is therefore again quite different from that of calcium and magnesium oxide.

A further indication of the variation in crystal lattice is apparently the fact that mixtures of calcium oxide and magnesium oxide which have the same overall constitution as the calcined dolomites and calcined huntites generally exhibit poorer performance than these. This indicates that calcining processes produce crystal lattices in particularly reactive forms, because relatively high-volume carbonate anions are replaced by low-volume oxide anions and the crystal lattices therefore have “cavities”. Lattice defects (defective sites, lattice expansion phenomena, and lattice disorientation phenomena) cause these crystal lattices to have relatively high energy contents attended by metastability, and this explains the relatively high activity of the stabilizer components (Ullmann's Enzyklopädie der technischen Chemie [Ullmann's Encyclopedia of Industrial Chemistry], Verlag Schwarzenberg/Minden-Berlin, 3rd edn. (1960), vol. 12, p. 125).

Calcined dolomite or calcined huntite is a preferred alkaline earth metal double carbonate. Particular preference is given to calcined dolomite, and very particular preference is given to calcium magnesium dioxide (A3). The range of concentration in the polymer containing halogen is preferably from 0.05 to 10 parts by weight per 100 parts by weight of polymer. It is particularly preferably used from 0.1 to 5 parts by weight.

A feature of the components or compounds (B) is that they contain nitrogen. The system of the invention can comprise one compound, or a plurality of compounds (B). The same applies to (A) and (C).

A general feature of the system of the invention is that it comprises at least (A) and (B) or (A) and (C). In the event that more than two, for example three or four, compounds selected from (A), (B), (C), and, if appropriate, from further compounds are present, it is preferable that (A), (B), and (C) are present.

The component or compound (B1) is preferably at least one trialkanolamine, one bisalkanol fatty acid amine, or one trisalkanol isocyanurate. It is possible to use one or more of these substances.

The component or compound (B1) is particularly preferably tert-alkanolamines, and preference is given here to tert-ethanolamines of the formula (B1-a1):

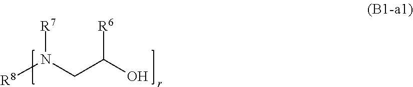

where r=1 or 2, R⁶═C₁-C₁₂-alkyl or CH₂OR⁹; R⁷, R⁸=independently of one another C₁-C₂₂-alkyl, C₃-C₂₂-alkenyl, and CH₂CHR^{6a}—OH; R⁹═C₁-C₂₀-alkyl, C₃-C₁₈-alkenyl and R¹⁰OCH₂CHR^{6a}OH—N(R⁷)(R⁸); R^{6a}=C₁-C₁₂-alkyl; R^{N}=C₂-C₁₀-alkylene or 1,4-dimethylol-cyclohexanediyl, where, if r=1, R⁷ and R⁸ combined is also —(CH₂)₄—, —(CH₂)₅—, —(CH₂)₂—O—(CH₂)₂—, —(CH₂)₂—N(CH₂CHR⁶—OH)—(CH₂)₂—, and —CON(CH₂CHR⁶—OH)—CON(CH₂CHR⁶—OH)CO— and if r=2, R⁸ also ═C₂-C₁₁-alkylene, which may have interruption by from 1 to 3 N(CH₂CHR⁶—OH) groups, or is 1,4-dimethylolcyclohexanediyl.

C₁-C₂₂-alkyl is preferably: methyl, ethyl, propyl, isopropyl, butyl, isobutyl, sec-butyl, tert-butyl, pentyl, isopentyl, hexyl, heptyl, octyl and decyl (including isomeric forms), undecyl, dodecyl, tridecyl, tetradecyl, hexadecyl, octadecyl, eicosyl, and docosyl; C₃-C₂₂-alkenyl: preferably allyl and oleyl; C₂-C₁₁-alkylene: preferably ethylene, propylene, isopropylene, butylene, isobutylene, pentylene, hexylene, octylene, decylene, and undecylene.

Preferred compounds of the formula (B1-a1) are trialkanolamines such as triethanolamine and trisalkanol isocyanurates (reaction products of cyanuric acid with alkene oxides), and also bisalkanol fatty acid amines (in particular with fatty acid=C₁₂-C₁₈ carboxylic acid or oleic or linoleic acid and alkanol=ethanol, isopropanol, and isobutanol), where very particular preference is given to oleyldiethanolamine, oleyldiisopropanolamine, and stearyldiethanolamine, and also to reaction products of monoglycidyl and diglycidyl ethers with diethanol- and diisopropanolamine, and to triethyl or triisopropyl isocyanurate.

Particular preference is given to triethanolamine, oleyldiethanolamine, and trishydroxyethyl isocyanurate (THEIC).

The component or compound (B2) is preferably at least one substituted aminouracil, one aminocrotonic ester, or one substituted urea. It is possible to use one or more of these substances.

All of the enaminones (B2-a) have the structural element R⁴NH—C═CH—CO—.

Among them are the enaminoesters (B2-a1) (aminocrotonic esters) and the aminopyrimidinones (B2-a2) and (B2-a3) (aminouracils), where these are preferably described via the following structures:

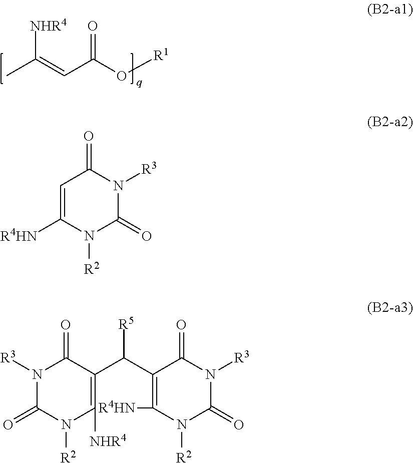

Among the substituted ureas (B2-b) are the phenylureas (B2-b1) and (B2-b2), and also the cyanoacetylureas (B2-b3), where these can be described via the following structural formulae:

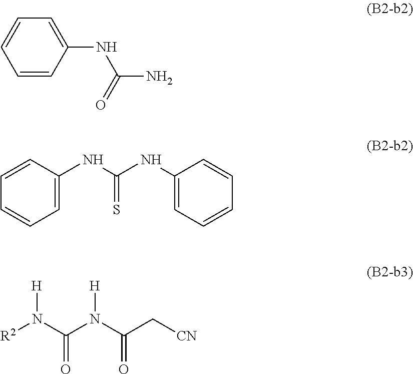

in which
R¹=unbranched or branched C₂-C₂₀-alkylene, which can have interruption by from 1 to 4 O or S atoms or/and can have substitution by from 1 to 4 OH groups, or is 1,4-dimethylolcyclohexanediyl, polyethylene (or -propylene) glycol-α,ω-diyl (poly=preferably tetra to deca), polyglyceryl-α,ω-diyl (poly=preferably tetra to deca) or glyceroltriyl, trimethylolethane (or -propane)triyl, pentaerythritoltri(or -tetra)yl, bistrimethylolethane (or -propane)tri(or -tetra)yl, diglyceroltri(or -tetra)yl, tetritoltetrayl, triglyceroltri(or -tetra or -penta)yl, pentitolpentayl, dipentaerythritolpenta (or -hexa)yl, and hexitolhexayl; and q=2-6.
R²=C₁-C₂₀-alkyl, C₃-C₆-alkenyl, C₇-C₉-phenylalkyl, or unsubstituted phenyl, or phenyl substituted with from 1 to 3 C₁-C₄-alkyl groups, with from 1 to 3 C₁-C₄-alkoxy groups or with from 1 to 3 hydroxy groups.
R³=R¹ or hydrogen.
R⁴=hydrogen, hydroxy-C₂-C₄-alkyl, hydroxyphenyl, C₁-C₄-alkoxyphenyl.
R⁵=C₁-C₂₀-alkyl.

It is preferable that: C₃-C₆-alkenyl is allyl, butenyl, and hexenyl; C₇-C₉-phenylalkyl is benzyl and phenetyl; phenyl substituted by hydroxy groups is o- and p-hydroxyphenyl; C₁-C₄-alkoxy is methoxy and ethoxy; phenyl substituted by C₁-C₄-alkoxy is o-methoxy- and p-methoxyphenyl. For further definitions, see under (B1).

The classes of substance (B2-a2) and (B2-a3) are to some extent commercially available, or can be synthesized by a method described in more detail in EP 0768 336, EP 1 510 545, EP 0 967 209, EP 0 967 208, EP 0 962 491 and EP 1 044 968. Representatives of the structures (B2-a1) are commercially available or can be produced as described in EP 433 230. Products of the formula (B2-b3) are likewise commercially available. The synthesis of these has been published by way of example in EP 0 962 491.

Preferred compounds of the formula (B2-a1) are bis-1,4-butanediyl 3-aminocrotonate and bisthiodiethanediyl 3-aminocrotonate.

Preferred aminouracils of the formulae (B2-a2) and (B2-a3) are 6-amino-1,3-dimethyluracil, 6-amino-1-octyluracil, 6-amino-1,3-dibenzyluracil, 6-(2-hydroxyanilino)-1,3-dimethyluracil, 6-(2-methoxyanilino)-1,3-dimethyluracil, 5,5′-heptylidenebis-6-amino-1,3-dimethyluracil, 5,5′-octylidenebis-6-amino-1,3-dimethyluracil, and 5,5′-dodecylidenebis-6-amino-1,3-dimethyluracil. Particular preference is given to 6-amino-1,3-dimethyluracil and 5,5′-dodecylidenebis-6-amino-1,3-dimethyluracil.

Preferred ureas of the formula (B2-b3) are cyanoacetyl-1,3-dialkyl(dibenzyl)ureas, and among these particular preference is given to cyanoacetyl-1,3-dimethylurea.

The concentration range for components (B1) and (B2) is preferably from 0.05 to 10 parts by weight, more preferably from 0.05 to 5 parts by weight, more preferably from 0.3 to 3 parts by weight, of the compound, based on 100 parts by weight of polymer containing halogen.

The component or compound (C) is an alkaline earth metal aluminohydroxocarbonate, and these can be described by the following formula:

(M₁₋ₓZnₓ)_{y}Al₂(OH)_{4+2y}CO_{3*}zH₂O (C)

where M=magnesium or/and calcium; x=from 0 to 0.5; y=from 2 to 8, and z=from 0 to 12.

The main representatives are the hydrotalcites class (Mg/Al- and Mg/Zn/Al-containing) and calcium carbonatohydroxodialuminates (Ca/Al-containing)

The component or compound (C) is preferably at least one magnesium aluminohydroxocarbonate or one magnesium zinc aluminohydroxocarbonate (C1), or one calcium carbonatohydroxodialuminate (C2). It is possible to use one or more of these substances.

### Hydrotalcites

The chemical constitution of these compounds is known to the person skilled in the art, e.g. from the following publications: DE-C 38.43.581 A1, U.S. Pat. No. 4,000,100, EP 0.062.813 A1 and WO 93/20135 and DE-C 102.17.364 A1 (Süd-Chemie). The constitution of these is as follows:

(Mg₁₋ₓZnₓ)_{y}Al₂(OH)_{4+2y}CO_{3*}zH₂O (C1)

where x=from 0 to 0.5; y=from 2 to 8, and z=from 0 to 12.

Examples of these are:

Al₂O₃*6MgO*CO₂*12 H₂O, Mg_{4,5}Al₂(OH)₁₃*CO₃*3,5 H₂O, 4MgO*Al₂O₃*CO₂*9 H₂O, 4MgO*Al₂O₃*CO₂*6 H₂O, ZnO*3MgO*Al₂O₃*CO₂*8-9 H₂O, and ZnO*3MgO*Al₂O₃*CO₂*5-6 H₂O

The following types are particularly preferred: Alcamizer 1 and 2, Alcamizer P 93-2 (Alcamizer 4) (producer: Kyowa Chemical Ind. Co., JP), and Sorbacid 911 (producer: SÜD-CHEMIE, DE). It is very particularly preferable to use dehydrated hydrotalcites.

### Calcium Carbonatohydroxodialuminates

Calcium carbonatohydroxodialuminates (CAHC) are new synthetic minerals which function as costabilizer in PVC (ADDCON 2007 3/6.09.2007, Frankfurt am Main). They can be described by the following idealized formula:

Ca₄Al₂(OH)₁₂CO_{3*}zH₂O (C2)

Addition of calcium magnesium dioxide here, just as with hydrotalcites, can give a synergistic performance improvement. The producer and supplier is NABALTEC AG, DE. The product is marketed as ACTILOX CAHC.

The amount of the compounds (C) present in the polymer can be from 0.005 to 9 parts by weight for every 100 parts by weight of polymer. Preferred amounts are from 0.05 to 5 parts by weight, very particularly from 0.5 to 3 parts by weight.

The following combinations are particularly preferred:

(A3 or A4)+(B1-a2), (A3 or A4)+(B1-a3) and (A3 or A4)+(B1-b3) (A3 or A4)+(B1-a2)+(C1), (A3 or A4)+(B1-a3)+(C1) and (A3 or A4)+(B1-b3)+(C1), (A3 or A4)+(B1-b3)+(C2), (A3 or A4)+(B1-a3)+(C1)
and also (A3 or A4)+(C1) and (A3 or A4)+(C2), where these also comprise trishydroxyethyl isocyanurate (THEIC).

Very particular preference is given to the following combinations (A3 or A4)+trialkanolamine or trishydroxyethyl isocyanurate.

The stabilizer system of the invention can also, if appropriate, comprise further additives, such as:
zeolites, dawsonites, and layer-lattice compounds
catena-μ-2,2′,2″-nitrilotrisethanolperchlorato (-triflato) inner complexes of sodium or of lithium or, respectively, perchlorates (triflates) of lithium or of sodium, respectively in dissolved form or on a carrier
the calcium or zinc salts of fatty acid (calcium soaps or zinc soaps)
polyols and sugar alcohols and/or 1,4-dihydropyridine derivatives (DHP)
linear or cyclic β-diketones and, respectively, β-ketoesters, and the calcium, magnesium, or zinc salts of these
phosphorous esters (phosphites) and sterically hindered amines
glycidyl compounds and epoxidized fatty acid esters
antioxidants, UV absorbers, and optical brighteners
pigments and biocides
fillers and blowing agents
lubricants and plasticizers
flame retardants and smoke suppressants.

### Zeolites

These compounds can be described by the formula M_{x/n}[(AlO₂)ₓ(SiO₂)_{y}]*w H₂O, in which n is the charge on the cation M; M is an element of the first or second main group, e.g. Li, Na, K, or NH₄, or else Mg, Ca, Sr, or Ba; y:x is a number from 0.8 to 15, preferably from 0.8 to 1.2; and w is a number from 0 to 300, preferably from 0.5 to 30.

Examples of zeolites are sodium aluminosilicates of the formulae Na₁₂Al₁₂Si₁₂O₄₈*27 H₂O [zeolite A], Na₆Al₆Si₆O₂₄*2 NaX*7.5 H₂O, X═OH, halogen, ClO₄ [sodalite]; Na₆Al₆Si₃₀O_{72*}24 H₂O; Na₈Al₈Si₄₀O₉₆*24 H₂O; Na₁₆Al₁₆Si₂₄O₈₀*16 H₂O; Na₁₆Al₁₆Si₃₂O₉₆*16 H₂O; Na₅₆Al₅₆Si₁₃₆O₃₈₄*250 H₂O [zeolite Y], Na₈₆Al₈₆Si₁₀₆O₃₈₄*264 H₂O [zeolite X]; Na₂O, Al₂O₃, (2-5)SiO₂, (3.5-10)H₂O [zeolite P]; Na₂O, Al₂O₃, 2SiO_{2,*}(3.5-10) H₂O (zeolite MAP); or the zeolites can be produced via partial or complete replacement of the Na atoms by Li, K, Mg, Ca, Sr, or Zn atoms, e.g. (Na,K)₁₀Al₁₀Si₂₂O₆₄*20 H₂O; Ca_{4.5}Na₃[(AlO₂)₁₂(SiO₂)₁₂]_{*}30 H₂O; K₉Na₃[(AlO₂)₁₂(SiO₂)₁₂]_{*}27 H₂O. Very particular preference is given to Na zeolite A and Na zeolite MAP (see also U.S. Pat. No. 6,531,533). Equal preference is given to zeolites with extremely small particle size, in particular of the Na-A and Na-P type, these also being described in U.S. Pat. No. 6,096,820.

### Layer-Lattice Compounds

Among these are titania hydrotalcites (Al/Mg/Ti/carbonate-containing), lithium hydrotalcites (Li/Al/carbonate- or Li/Mg/Al/carbonate-based), and calcium aluminum hydroxohydrogenphosphites, as described in DE-C 44.25266 A1 (Metallgesellschaft), EP 0.549.340 A1 (Mizusawa Ind. Chem.) and JP 0.761.756 A1 (Fuji Chem. Ind.). They can be described via the following general formula:

M²⁺₁₋ₓM³⁺ₓ(OH)₂(Aⁿ)_{x/b}*dH₂O

where
M²⁺=as cation, one or more of the metals from the group of Mg, Ca, Sr, Zn, or Sn,
M³⁺=as cation Al or B, Aⁿ is an anion of valency −n,
b=n is a number from 1 to 2, 0<x<0.5, d is a number from 0 to 20. Preference is given to compounds having
Aⁿ═OH⁻, ClO₄⁻, HCO₃⁻, CH₃COO⁻, C₆H₅COO⁻, CO₃²⁻, (CHOHCOO)₂²⁻, (CH₂COO)₂²⁻, CH₃CHOHCOO⁻, HPO₃⁻, or HPO₄²⁻.

### Titania Hydrotalcites

Titanium-containing hydrotalcites are described in WO 95/21127. It is equally possible to use compounds of this type having the general formula AlₐMg_{b}Ti_{c}(OH)_{d}(CO₃)ₑ*m H₂O, where a:b=from 1:1 to 1:10; and 2≦b≦10; 0<c<5; 0≦m<5, and the selection of d and e is such as to produce a basic, charge-free molecule.

### Lithium Hydrotalcites

Lithium-aluminum layer-lattice compounds have the general formula:

LiₐM^{II}_{(b-2a)}Al₍₂₊ₐ₎OH_{(4+2b)}(Aⁿ⁻)_{(2/n)*}mH₂O

in which

### M^{II} is Mg, Ca, or Zn, and

Aⁿ is a selected anion of valency n or a mixture of anions, and the indices are in the following ranges:
0<a<(b−2)/2,
1<b<6, and
m=from 0 to 30,
with the proviso that (b−2a)>2, or have
the general formula:

[Al₂(Li₍₁₋ₓ₎.M^{II}ₓ)(OH)₆]ₙ(Aⁿ⁻)₁₊ₓ₎*m H₂O

in which
M^{II}, A, m, and n are defined as above, and
x complies with the condition 0.01≦x<1.

The production of these layer-lattice compounds is characterized in that lithium hydroxide, lithium oxide, and/or compounds thereof that can be converted to hydroxide, metal(II) hydroxides, metal(II) oxides, and/or compounds of these that can be converted into hydroxides of these metals, and aluminum hydroxides and/or compounds of these that can be converted into hydroxides, and also acids and/or salts of these, or mixtures thereof, are reacted with one another at pH of from 8 to 10 and at temperatures of from 20 to 250° C. in an aqueous medium, and the resultant solid reaction product is isolated.

The reaction time is preferably from 0.5 to 40 hours, in particular from 3 to 15 hours. The reaction product directly produced from the reaction described above can be isolated by known methods from the aqueous reaction medium, preferably via filtration. The isolated reaction product is also worked up in a manner known per se, for example via washing of the filter cake with water and drying of the washed residue at temperatures of, for example, from 60 to 150° C., preferably from 90 to 120° C.

For the reaction using aluminum, it is possible to use either fine-particle, active metal(III) hydroxide in combination with sodium hydroxide or an NaAlO₂. Lithium or one of the abovementioned metal(II) compounds can be used in the form of fine-particle lithium oxide or fine-particle lithium hydroxide or a mixture thereof, or in the form of fine-particle metal(II) oxide or fine-particle metal(II) hydroxide, or a mixture thereof. The corresponding acid anions can be used in various concentrations, e.g. directly in the form of acid or else in the form of salt.

The reaction temperatures are preferably from about 20 to 250° C., more particularly from about 60 to 180° C. There is no requirement for catalysts or accelerators. The water of crystallization in the substances can be removed completely or to some extent by treatment. When the dried layer-lattice compounds are used as stabilizers, at the processing temperatures conventional for PVC, from 160 to 220° C., they do not evolve any water or other gas, and no problematic blistering therefore occurs within the moldings.

The anions Aⁿ in the above general formula can be sulfate, sulfite, sulfide, thiosulfate, peroxosulfate, peroxodisulfate, hydrogenphosphate, hydrogenphosphite, carbonate, halides, nitrate, nitrite, hydrogensulfate, hydrogencarbonate, hydrogensulfite, hydrogensulfide, dihydrogenphosphate, dihydrogenphosphite, monocarboxylic anions, such as acetate and benzoate, amide, azide, hydroxide, hydroxylamine, hydroazide, acetylacetonate, phenolate, pseudohalides, halites, halates, perhalates, I₃⁻, permanganate, dianions of dicarboxylic acids, e.g. phthalate, oxalate, maleate, or fumarate, bisphenolates, phosphate, pyrophosphate, phosphite, pyrophosphite, trianions of tricarboxylic acids, e.g. citrate, trisphenolates, etc., and also mixtures thereof. Among these, preference is given to hydroxide, carbonate, phosphite, and maleate. In order to improve the dispersibility of the substances in thermoplastic polymer compositions containing halogen, the same can have been coated with a higher fatty acid, e.g. stearic acid, or with anionic surfactant, or with a silane coupling agent, or with a titanate coupling agent, or with a glycerol fatty acid ester.

### Calcium Aluminum Hydroxohydrogenphosphites

Compounds which are suitable for the stabilizer combinations of the invention and which belong to the group of the basic calcium aluminum hydroxyhydrogenphosphites of the general formula

CaₓAl₂(OH)₂₍ₓ₊₂₎HPO_{3*}H₂O,

where x=2-8, and

CaₓAl₂(OH)_{2(x+3-y)}(HPO₃)_{y*}mH₂O

where x=2-12,

$$\frac{2 x + 5}{2} > y > 0$$

and m=from 0 to 12, excepting y=1, if x=from 2 to 8
can by way of example be produced by means of a process in which mixtures of calcium hydroxide and/or calcium oxide, aluminum hydroxide and sodium oxide, or of calcium hydroxide and/or calcium oxide and sodium aluminate, are reacted in an aqueous medium with an amount of phosphorous acid appropriate for producing the desired calcium aluminum hydroxyhydrogenphosphites, where the reaction product is isolated and obtained in a manner known per se. The reaction product directly produced from the reaction described above can be isolated from the aqueous reaction medium by known methods, for example via washing of the filter cake with water and drying of the washed residue at temperatures of, for example, from 60 to 130° C., preferably from 90 to 120° C.

The reaction can use either fine-particle, active aluminum hydroxide in combination with sodium hydroxide or else a sodium aluminate. Calcium can be used in the form of fine-particle calcium oxide or calcium hydroxide, or a mixture thereof. The phosphorous acid can be used at various concentrations. The reaction temperatures are preferably from 50 to 100° C., more preferably from about 60 to 85° C. There is no requirement for catalysts or accelerators, but they have no adverse effect, the water of crystallization in the compounds can be removed entirely or to some extent via heat treatment.

When the dried calcium aluminum hydroxyphosphites are used as stabilizers at the processing temperatures conventional for rigid PVC, for example of from 160 to 200° C., they do not evolve any water, and no problematic blistering therefore occurs in the moldings.

In order to improve the dispersibility of the compounds in thermoplastic resins containing halogen, the compounds can be coated with surfactant in a known manner. This class of compound, also termed CHAP compounds or CAP compounds, is described in EP 0.506.831A1

The calcium aluminum hydroxohydrogenphosphites and titanium-containing hydrotalcites described above can be not only crystalline but also semicrystalline and/or amorphous.

### Dawsonites (Alkali Metal Aluminocarbonates)

These are described via the general formula

M[Al(OH)₂CO₃](M═Na,K).

The production of Na dawsonite (DASC or SAC) and of K dawsonites (DAPC or PAC) has been published in U.S. Pat. No. 3,501,264 and U.S. Pat. No. 4,221,771, and also in EP 0394.670 Al. A hydrothermal or nonhydrothermal method can be used for the synthesis. The products can be crystalline or amorphous. The class of substance also includes sodium magnesium aluminocarbonates (SMAC); the production of these is described in U.S. Pat. No. 455,055,284.

Examples of the amounts that can be used of calcium aluminum hydroxohydrogenphosphites and/or zeolites, and/or dawsonites, and/or layer-lattice compounds are from 0.1 to 20 parts by weight, advantageously from 0.1 to 10 parts by weight, and in particular from 0.1 to 5 parts by weight, based on 100 parts by weight of polymer containing halogen.

### Catena-μ-2,2′,2″-nitrilotrisethanolperchlorato(triflato) sodium or lithium

These four inner complexes are coordination polymers having the following monomer unit:

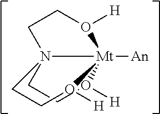

where

### Mt═Li or Na

### An═OClO₃ or OS(O₂)CF₃

It is preferable that An=OClO₃, and it is particularly preferable that Mt=Na (TEAP). The use of these compounds as stabilizers is described in WO 2006/136191. Very particular preference is given to phlegmatization of concentrated aqueous TEAP solutions on PVC. This production process is described in the German patent application with application number DE 10 2007 050 428.6.

### Sodium (Lithium) Perchlorate (Triflate) in Dissolved Form or on a Carrier

These salts of lithium or of sodium can be used in the form of solutions, preference being given here to the following solvents: water, glycols, glycol ethers, (poly)glycerols, and polyglycol ethers.

However, particular preference is given to formulations of the salts on carriers, where the salt in dissolved form (mostly aqueous) is ab(ad)sorbed with homogeneous distribution on a solid carrier. Carrier substances that may be mentioned are: silicon dioxide (kieselguhr), calcium silicate, calcium carbonate, calcium oxide, calcium hydroxide, Na zeolite A, hydrotalcite, and calcined dolomite, preference being given to the latter.

These compounds of sodium or of lithium exhibit a booster effect in PVC, preferably in zinc-free formulations. The amounts of these preferably used in the substrate are advantageously from 0.001 to 5 phr, with preference from 0.01 to 3 phr, and with very particular preference from 0.01 to 2 phr.

The compounds of this category are preferably combined with systems which are free from zinc carboxylates, but which comprise (B1) or/and (B2).

### Metal Soaps

Calcium soaps are mainly calcium carboxylates, preferably those of relatively long-chain carboxylic acids. Familiar examples are stearates and laurates, and also oleates and salts of shorter-chain aliphatic or aromatic carboxylic acids, e.g. acetic acid, propionic acid, butyric acid, valeric acid, hexanoic acid, sorbic acid; oxalic acid, malonic acid, succinic acid, glutaric acid, adipic acid, fumaric acid, citric acid, benzoic acid, salicylic acid, phthalic acids, hemimellitic acid, trimellitic acid, pyromellitic acid, and also the calcium carboxylates that are termed overbased.

Preference is given to calcium laurate, calcium stearate, calcium behenate, calcium versatate, and calcium abietate.

### Zinc Soaps

The zinc soaps are mainly zinc carboxylates. These are compounds from the group of the aliphatic saturated and unsaturated C₁₋₂₂ carboxylates, the aliphatic saturated or unsaturated C₂₋₂₂ carboxylates having substitution with at least one OH group, or having interruption at least by one or more O atoms in the chain thereof (oxaacids), the cyclic and bicyclic carboxylates having from 5 to 22 carbon atoms, the unsubstituted phenylcarboxylates, and the phenylcarboxylates which have substitution with at least one OH group and/or have C₁₋₁₆-alkyl substitution, the phenyl-C₁₋₁₆-alkylcarboxylates, or the phenolates optionally substituted with C₁₋₁₂-alkyl, or abietic acid. Examples of Zn—S compounds are Zn mercaptides, Zn mercaptocarboxylates, and Zn mercaptocarboxylic esters.

Examples that may be mentioned by name are the zinc salts of the monovalent carboxylic acids, e.g. formic acid, acetic acid, propionic acid, butyric acid, valeric acid, hexanoic acid, enanthic acid, octanoic acid, neodecanoic acid, 2-ethylhexanoic acid, pelargonic acid, decanoic acid, undecanoic acid, dodecanoic acid, tridecanoic acid, myristic acid, palmitic acid, lauric acid, isostearic acid, stearic acid, 12-hydroxystearic acid, 9,10-dihydroxystearic acid, oleic acid, ricinoleic acid, 3,6-dioxaheptanoic acid, 3,6,9-trioxadecanoic acid, behenic acid, benzoic acid, p-tert-butylbenzoic acid, dimethylhydroxybenzoic acid, 3,5-di-tert-butyl-4-hydroxybenzoic acid, tolylic acid, dimethylbenzoic acid, ethylbenzoic acid, n-propylbenzoic acid, salicylic acid, p-tert-octylsalicylic acid, and sorbic acid, cinammic acid, mandelic acid, glycolic acid; zinc salts of the divalent carboxylic acids and, respectively, monoesters of these, e.g. oxalic acid, malonic acid, succinic acid, glutaric acid, adipic acid, fumaric acid, pentane-1,5-dicarboxylic acid, hexane-1,6-dicarboxylic acid, heptane-1,7-dicarboxylic acid, octane-1,8-dicarboxylic acid, 3,6,9-trioxadecane-1,10-dicarboxylic acid, lactic acid, malonic acid, maleic acid, tartaric acid, malic acid, salicylic acid, polyglycol dicarboxylic acid (n=from 10 to 12), phthalic acid, isophthalic acid, terephthalic acid and hydroxyphthalic acid; and the di- or triesters of the tri- or tetrabasic carboxylic acids, e.g. hemimellitic acid, trimellitic acid, pyromellitic acid, citric acid, and also the zinc carboxylates that are termed overbased, or zinc lauryl mercaptide, zinc thioglycolate, zinc thiosalicylate, zinc bis-isooctylthioglycolate, zinc mercaptopropionate, zinc thiolactate, zinc thiomalate, zinc bis-octylmercaptopropionate, zinc bisisooctylthiolactate, and zinc bislaurylthiomalate.

It is also possible to use inorganic zinc compounds, such as zinc oxide, zinc hydroxide, zinc carbonate, or basic zinc carbonate.

Preference is given to neutral or basic zinc carboxylates of a carboxylic acid having from 1 to 22 carbon atoms (zinc soaps), e.g. benzoates or alkanoates, preferably C₈-alkanoates, stearate, oleate, laurate, palmitate, behenate, versatate, hydroxystearates, and hydroxyoleates, dihydroxystearates, p-tert-butylbenzoate, or (iso)octanoate. Particular preference is given to stearate, laurate, oleate, versatate, behenate, benzoate, p-tert-butylbenzoate, 2-ethylhexanoate, and abietate.

The amount that can be used of the metal soaps or mixtures of these is by way of example from 0.001 to 10 parts by weight, advantageously from 0.01 to 8 parts by weight, particularly preferably from 0.05 to 5 parts by weight, based on 100 parts by weight of PVC.

### Polyols and Sugar Alcohols

Examples of compounds of this type that can be used are: pentaerythritol, dipentaerythritol, tripentaerythritol, trimethylolethane, bistrimethylolpropane, inositol, polyvinyl alcohol, bistrimethylolethane, trimethylolpropane, sorbitol, maltitol, isomaltitol, Lycasin, mannitol, lactose, leucrose, disaccharide alcohols, such as lactitol, maltitol, and palatinitol, tetramethylcyclohexanol, tetramethylolcyclopentanol, tetramethylolpyranol, glycerol, diglycerol, polyglycerol, thiodiglycerol, or 1-O-∝-D-glycopyranosyl-D-mannitol dihydrate. Preference is given to disaccharide alcohols. Polyol syrups are also used, e.g. sorbitol syrup, mannitol syrup, and maltitol syrup.

### Dihydropyridine Derivatives (DHP)

These are described by the following general formula:

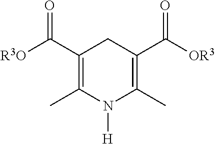

or poly-1,4-dihydropyridine*
   *=The structure of the substituted poly-1,4-dihydropyridines is described in WO2006/0136191.
   in which
   R³=C₁-C₂₀-alkyl, C₃-C₆-alkenyl, C₇-C₉-phenylalkyl, or unsubstituted phenyl, or phenyl substituted with from 1 to 3 C₁-C₄-alkyl, C₁-C₄-alkoxy, or hydroxy groups.

An example of the amounts that can be used of the polyols and dihydropyridines is from 0.01 to 20 parts by weight, advantageously from 0.1 to 20 parts by weight, and in particular from 0.1 to 10 parts by weight, based on 100 parts by weight of PVC.

Linear or Cyclic β-Diketones and β-Ketoesters, and Also Metal Salts of these

1,3-Dicarbonyl compounds that can be used are linear or cyclic dicarbonyl compounds. Preference is given to dicarbonyl compounds of the formula R′₁C0 CHR₂—COR′₃, in which R′₁ is C₁-C₂₂-alkyl, C₅-C₁₀-hydroxyalkyl, C₂-C₁₈-alkenyl, or phenyl, OH—, C₁-C₄-alkyl-, C₁-C₄-alkoxy-, or halogen-substituted phenyl, C₇-C₁₀-phenylalkyl, C₅-C₁₂-cycloalkyl, C₁-C₄-alkyl-substituted C₅-C₁₂-cycloalkyl, or a —R′₅—S—R′₆ group or —R′₅—O—R′₆; R′₂ is hydrogen, C₁-C₈-alkyl, C₂-C₁₂-alkenyl, phenyl, C₇-C₁₂-alkylphenyl, C₇-C₁₀-phenylalkyl, or a —CO—R′₄ group; R′₃ has one of the meanings stated for R′₁, or is C₁-C₁₈-alkoxy, R′₄ is C₁-C₄-alkyl or phenyl; R′₅ is C₁-C₁₀-alkylene, and R′₆ is C₁-C₁₂-alkyl, phenyl, C₇-C₁₈-alkylphenyl, or C₇-C₁₀-phenylalkyl.

Among these are the diketones containing hydroxy groups, EP 0.346.279 A1 and the oxa- and thiadiketones in EP 0.307.358 A1, and also the isocyanuric-acid-based ketoesters in U.S. Pat. No. 4,339,383 (THEIC esters).

R′₁ and R′₃ as alkyl can in particular be C₁-C₁₈-alkyl, e.g. methyl, ethyl, n-propyl, isopropyl, n-butyl, tert-butyl, pentyl, hexyl, heptyl, octyl, decyl, dodecyl, or octadecyl. R′₁ and R′₃ as hydroxyalkyl are in particular a —(CH₂)ₙ—OH group, in which n is 5, 6, or 7.

R′₁ and R′₂ as alkenyl can by way of example be vinyl, allyl, methallyl, 1-butenyl, 1-hexenyl or oleyl, preferably allyl.

R′₁ and R′₃ as OH, alkyl-, alkoxy-, or halogen-substituted phenyl can by way of example be tolyl, xylyl, tert-butylphenyl, methoxyphenyl, ethoxyphenyl, hydroxyphenyl, chlorophenyl, or dichlorophenyl.

R′₁ and R′₃ as phenylalkyl are in particular benzyl. R′₂ and R′₃ as cycloalkyl or alkylcycloalkyl are in particular cyclohexyl or methylcyclohexyl.

R′₂ as alkyl can in particular be C₁-C₄-alkyl. R′₂ as C₂-C₁₂-alkenyl can in particular be allyl. R′₂ as alkylphenyl can in particular be tolyl. R′₂ as phenylalkyl can in particular be benzyl. It is preferable that R′₂ is hydrogen. R′₃ as alkoxy can by way of example be methoxy, ethoxy, butoxy, hexyloxy, octyloxy, dodecyloxy, tridecyloxy, tetradecyloxy, or octadecyloxy. R′₅ as C₁-C₁₀-alkylene is in particular C₂-C₄-alkylene. R′₆ as alkyl is in particular C₄-C₁₂-alkyl, e.g. butyl, hexyl, octyl, decyl, or dodecyl.

R′₆ as alkylphenyl is in particular tolyl. R′₆ as phenylalkyl is in particular benzyl.

Examples of 1,3-dicarbonyl compounds of the above general formula, and also the alkali metal, alkaline earth metal, and zinc chelates of these, are acetylacetone, butanoylacetone, heptanoylacetone, stearoylacetone, palmitoylacetone, lauroylacetone, 7-tert-nonylthioheptane-2,4-dione, benzoylacetone, dibenzoylmethane, lauroylbenzoylmethane, palmitoylbenzoylmethane, stearoylbenzoylmethane, isooctylbenzoylmethane, 5-hydroxy-capronylbenzoylmethane, tribenzoylmethane, bis(4-methylbenzoyl)methane, benzoyl-p-chlorobenzoylmethane, bis(2-hydroxybenzoyl)methane, 4-methoxybenzoylbenzoylmethane, bis(4-methoxybenzoyl)methane, 1-benzoyl-1-acetylnonane, benzoylacetylphenylmethane, stearoyl-4-methoxybenzoylmethane, bis(4-tert-butylbenzoyl)methane, benzoylformylmethane, benzoylphenylacetylmethane, biscyclohexanoylmethane, dipivaloylmethane, 2-acetylcyclopentanone, 2-benzoylcyclopentanone, methyl, ethyl, and allyl diacetoacetate, methyl and ethyl benzoyl-, propionyl-, and butyrylacetoacetate, triacetylmethane, methyl, ethyl, hexyl, octyl, dodecyl, or -octadecyl acetoacetate, methyl, ethyl, butyl, 2-ethylhexyl, dodecyl, or octadecyl benzoylacetoacetate, and also C₁-C₁₈-alkyl esters of propionyl- and butyrylacetic acid, ethyl, propyl, butyl, hexyl, or octyl stearoylacetate, and also polynuclear β-ketoesters as described in EP-A 0 433 230, and dehydroacetic acid, and also the zinc, magnesium, or alkaline earth metal salts thereof. Preference is given to the Ca, Mg, and Zn salts of acetylacetone and of dehydroacetic acid.

Particular preference is given to 1,3-diketo compounds of the above formula in which R′₁ is C₁-C₁₈-alkyl, phenyl, OH—, methyl-, or methoxy-substituted phenyl, C₇-C₁₀-phenylalkyl, or cyclohexyl, R′₂ is hydrogen, and R′₃ has one of the meanings stated for R′₁. The compounds here also include heterocyclic 2,4-diones, such as N-phenyl-3-acetylpyrrolidine-2,4-dione. Further representatives of this category are described in EP 0.734.414 A1. An example of an amount that can be used of the 1,3-diketo compounds is from 0.01 to 10 parts by weight, advantageously from 0.01 to 3 parts by weight, and in particular from 0.01 to 2 parts by weight, based on 100 parts by weight of PVC.

### Phosphorous Esters (Phosphites)

Examples of these are trioctyl, tridecyl, tridodecyl, tritridecyl, tripentadecyl, trioleyl, tristearyl, triphenyl, trilauryl, tricresyl, trisnonylphenyl, tris-2,4-tert-butylphenyl, or tricyclohexyl phosphite. Other suitable phosphites are various mixtures of aryl dialkyl or alkyl diaryl phosphites, e.g. phenyl dioctyl, phenyl didecyl, phenyl didodecyl, phenyl ditridecyl, phenyl ditetradecyl, phenyl dipentadecyl, octyl diphenyl, decyl diphenyl, undecyl diphenyl, dodecyl diphenyl, tridecyl diphenyl, tetradecyl diphenyl, pentadecyl diphenyl, oleyl diphenyl, stearyl diphenyl, and dodecyl bis-2,4-di-tert-butylphenyl phosphite. It is also advantageously possible to use phosphites of various di- or polyols, e.g. tetraphenyl dipropylene glycol diphosphite, poly(dipropylene glycol) phenyl phosphite, tetraisodecyl dipropylene glycol diphosphite, trisdipropylene glycol phosphite, tetramethylolcyclohexanol decyl diphosphite, tetramethylolcyclohexanol butoxyethoxyethyl diphosphite, tetramethylolcyclohexanol nonylphenyl diphosphite, bisnonylphenylditrimethylolpropane diphosphite, bis-2-butoxyethylditrimethylolpropane diphosphite, trishydroxyethyl isocyanurate hexadecyl triphosphite, didecyl pentaerythritol diphosphite, distearyl pentaerythritol diphosphite, bis-2,4-di-tert-butylphenyl pentaerythritol diphosphite, and also mixtures of these phosphites, and aryl/alkyl phosphite mixtures of statistical composition (H₁₉C₉-C₆H₄)O_{1.5}P(OC_{12,13}H_{25,27})_{1.5}, or (C₈H₁₇—C₆H₄—O—)₂P(iso-C₈H₁₇O),(H₁₉C₉—C₆H₄)O_{1.5}P(OC_{9,11}H_{19,23})_{1.5}. Industrial examples are Naugard P, Mark CH300, Mark CH301, Mark CH302, and Mark CH55 (producer: Chemtura Corp. USA). An example of an amount that can be used of the organic phosphites is from 0.01 to 10 parts by weight, advantageously from 0.05 to 5 parts by weight, and in particular from 0.1 to 3 parts by weight, based on 100 parts by weight of PVC.

A stabilizer system of the invention can comprise an amount of up to about 30% by weight, in particular up to about 10% by weight, of the phosphite compounds described.

### Sterically Hindered Amines (HALS)

The sterically hindered amines are generally compounds containing the following group

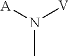

in which A and V, independently of one another, are C₁₋₈-alkyl, C₃₋₈-alkenyl, C₅₋₈-cycloalkyl, or C₇₋₉-phenylalkyl, or together, if appropriate, form C₂₋₅-alkylene, if appropriate having interruption by O, by NH, or by CH₃—N, or the sterically hindered amine may be cyclic, in particular a compound from the class of the alkyl- or polyalkylpiperidines, especially of the tetramethylpiperidines containing the following group

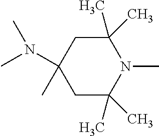

Examples of these polyalkylpiperidine compounds are as follows (where, in the case of the oligomeric or polymeric compounds, n and r are in the range from 2 to 200, preferably in the range from 2 to 10, in particular from 3 to 7). A comprehensive list of these compounds is found in EP 0 796 888 B1.

An example of the content of sterically hindered amines in a stabilizer system of the invention is from about 0.01 to about 10% by weight.

### Glycidyl Compounds

Examples of glycidyl compounds are compounds having the glycidyl group:

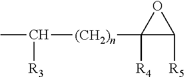

which can have direct bonding to carbon atoms, to oxygen atoms, to nitrogen atoms, or to sulfur atoms, and in which either both of R₃ and R₅ are hydrogen, R₄ is hydrogen or methyl, and n=0, or in which R₃ and R₅ together are —CH₂—CH₂— or —CH₂—CH₂—CH₂—, and R₄ is then hydrogen, and n=0 or 1.

I) Glycidyl and β-methylglycidyl esters obtainable via reaction of a compound having at least one carboxy group in the molecule and epichlorohydrin and, respectively, glycerol dichlorohydrin and, respectively, β-methylepichlorohydrin. The reaction is usefully carried out in the presence of bases.

Compounds that can be used that have at least one carboxy group in the molecule are aliphatic carboxylic acids. Examples of these carboxylic acids are glutaric acid, adipic acid, pimelic acid, suberic acid, azelaic acid, sebacic acid, or dimerized or trimerized linoleic acid, acrylic and methacrylic acid, caproic acid, caprylic acid, pelargonic acid, lauric acid, myristic acid, palmitic acid, and stearic acid.

However, it is also possible to use cycloaliphatic carboxylic acids, e.g. cyclohexanecarboxylic acid, tetrahydrophthalic acid, 4-methyltetrahydrophthalic acid, hexahydrophthalic acid, or 4-methylhexahydrophthalic acid.

Aromatic carboxylic acids can also be used, examples being benzoic acid, phthalic acid, isophthalic acid, trimellitic acid, or pyromellitic acid.

It is also possible to use carboxy-terminated adducts, e.g. of trimellitic acid and of polyols, such as glycerol or 2,2-bis(4-hydroxycyclohexyl)propane. EP 0 506 617 reveals further epoxy compounds that can be used for the purposes of this invention.

II) Glycidyl or β-methylglycidyl ethers obtainable via reaction of a compound having at least one free alcoholic hydroxy group and/or phenolic hydroxy group with a suitably substituted epichlorohydrin under alkaline conditions, or in the presence of an acidic catalyst with subsequent alkali treatment.

Ethers of this type derive by way of example from acyclic alcohols, such as ethylene glycol, diethylene glycol, and higher poly(oxyethylene) glycols, propane-1,2-diol, or poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylolpropane, bistrimethylolpropane, pentaerythritol, or sorbitol, or else from polyepichlorohydrins, butanol, amyl alcohol, or pentanol, or else from monohydric alcohols, such as isooctanol, 2-ethylhexanol, or isodecanol, or else from C₇-C₉-alkanol mixtures and C₉-C₁₁-alkanol mixtures.

However, they also derive by way of example from cycloaliphatic alcohols, such as 1,3- or 1,4-dihydroxycyclohexane, bis(4-hydroxycyclohexyl)methane, 2,2-bis(4-hydroxycyclohexyl)propane, or 1,1-bis(hydroxymethyl)cyclohex-3-ene, or they can have aromatic rings, examples being N,N-bis(2-hydroxyethyl)aniline, or p,p′-bis(2-hydroxyethylamino)diphenylmethane.

The epoxy compounds can also derive from mononuclear phenols, for example from phenol, resorcinol, or hydroquinone; or they can be based on polynuclear phenols, for example on bis(4-hydroxyphenyl)methane, 2,2-bis(4-hydroxyphenyl)propane, 2,2-bis(3,5-dibromo-4-hydroxyphenyl)propane, 4,4′-dihydroxydiphenyl sulfone, or condensates obtained under acidic conditions from phenols with formaldehyde, e.g. phenol novolacs.

Examples of other possible terminal epoxides are: glycidyl 1-naphthyl ether, glycidyl 2-phenylphenyl ether, 2-biphenyl glycidyl ether, N-(2,3-epoxypropyl)phthalimide, and 2,3-epoxypropyl 4-methoxyphenyl ether.

III) N-Glycidyl compounds attainable via dehydrochlorination of the reaction products of epichlorohydrin with amines containing at least one amino hydrogen atom. Examples of these amines are aniline, N-methylaniline, toluidine, n-butylamine, bis(4-aminophenyl)methane, m-xylylenediamine, and bis(4-methylaminophenyl)methane, and also N,N,O-triglycidyl-m-aminophenol and N,N,O-triglycidyl-p-aminophenol.

However, among the N-glycidyl compounds are also N,N′-di-, N,N′,N″-tri-, and N,N′,N″,N′″-tetraglycidyl derivatives of cycloalkyleneureas, such as ethyleneurea or 1,3-propyleneurea, and N,N′-diglycidyl derivatives of hydantoins, e.g. of 5,5-dimethylhydantoin or glycoluril and triglycidyl isocyanurate.

IV) S-Glycidyl compounds, such as di-S-glycidyl derivatives, where these derive from dithiols, such as ethane-1,2-dithiol, or bis(4-mercaptomethylphenyl)ether.

V) Epoxy compounds having a radical of the above formula in which R₁ and R₃ together are —CH₂—CH₂— and n is 0 are bis(2,3-epoxycyclopentyl)ether, 2,3-epoxycyclopentyl glycidyl ether, or 1,2-bis(2,3-epoxycyclopentyloxy)ethane. An example of an epoxy resin having a radical of the above formula in which R₁ and R₃ together are —CH₂—CH₂— and n is 1 is 3′,4′-epoxy-6′-methylcyclohexylmethyl 3,4-epoxy-6-methylcyclohexanecarboxylate.

Examples of suitable terminal epoxides are:

a) liquid bisphenol A diglycidyl ethers, such as Araldit®GY 240, Araldit®GY 250, Araldit®GY 260, Araldit®GY 266, Araldit®GY 2600, Araldit®MY 790, and Epicote® 828 (BADGE);
b) solid bisphenol A diglycidyl ethers, such as Araldit®GT 6071, Araldit®GT 7071, Araldit®GT 7072, Araldit®GT 6063, Araldit®GT 7203, Araldit®GT 6064, Araldit®GT 7304, Araldit®GT 7004, Araldit®GT 6084, Araldit®GT 1999, Araldit®GT 7077, Araldit®GT 6097, Araldit®GT 7097, Araldit®GT 7008, Araldit®GT 6099, Araldit®GT 6608, Araldit®GT 6609, Araldit®GT 6610, and Epikote® 1002;
c) liquid bisphenol F diglycidyl ethers, such as Araldit®GY 281, Araldit®PY 302, Araldit®PY 306 (BFDGE);
d) solid polyglycidyl ethers of tetraphenylethane, such as CG Epoxy Resin®0163;
e) solid and liquid polyglycidyl ethers of phenol-formaldehyde novolac, such as EPN 1138, EPN 1139, GY 1180, PY 307 (NODGE);
f) solid and liquid polyglycidyl ethers of o-cresol-formaldehyde novolac, such as ECN 1235, ECN 1273, ECN 1280, ECN 1299 (NODGE);
g) liquid glycidyl ethers of alcohols, such as Shell Glycidylether® 162, Araldit®DY 0390, Araldit®DY 0391;
h) liquid and solid glycidyl esters of carboxylic acids, examples being Shell Cardura® E terephthalic esters, trimellitic esters, and also mixtures of these, Araldit®PY 284 and Araldit® P811
i) solid heterocyclic epoxy resins (triglycidyl isocyanurate), such as Araldit® PT 810;
j) liquid cycloaliphatic epoxy resins, such as Araldit®CY 179;
k) liquid N,N,O-triglycidyl ethers of p-aminophenol, such as Araldit®MY 0510;
l) tetraglycidyl-4-4′-methylenebenzamine or N,N,N′,N′-tetraglycidyldiaminophenyl-methane, such as Araldit®MY 720, Araldit®MY 721.

Ether- or ester-based diglycidyl compounds are mainly used. Very particular preference is given to solid glycidyl esters of terephthalic and trimellitic acid.

It is also possible, if appropriate, to use a mixture of various epoxy compounds.

### Epoxidized Fatty Acid Esters

Examples of these epoxy compounds are epoxidized soy oil, epoxidized olive oil, epoxidized linseed oil, epoxidized castor oil, epoxidized peanut oil, epoxidized maize oil, and epoxidized cottonseed oil, epoxidized rapeseed oil, epoxidized palm oil, epoxidized coconut oil, and also epoxidized butyl and octyl oleate, or epoxidized linoleic esters and, respectively, linolenic esters.

The concentration range for epoxy compounds is preferably from 0.5 to 5.0 phr.

### Antioxidants

Among these are sterically hindered phenols, such as alkylated monophenols, e.g. 2,6-di-tert-butyl-4-methylphenol, alkylthiomethylphenols, e.g. 2,4-dioctylthiomethyl-6-tert-butylphenol, alkylated hydroquinones, e.g. 2,6-di-tert-butyl-4-methoxyphenol, hydroxylated thiodiphenyl ethers, e.g. 2,2′-thiobis(6-tert-butyl-4-methylphenol), alkylidenebisphenols, e.g. 2,2′-methylenebis(6-tert-butyl-4-methylphenol), benzyl compounds, e.g. 3,5,3′,5′-tetra-tert-butyl-4,4′-dihydroxydibenzyl ether, hydroxybenzylated malonates, e.g. dioctadecyl 2,2-bis-(3,5-di-tert-butyl-2-hydroxybenzyl)malonate, hydroxybenzylaromatic compounds, e.g. 1,3,5-tris(3,5-di-tert-butyl-4-hydroxybenzyl)-2,4,6-trimethylbenzene, triazine compounds, e.g. 2,4-bisoctylmercapto-6-(3,5-di-tert-butyl-4-hydroxyanilino)-1,3,5-triazine, phosphonates, and phosphonites, e.g. dimethyl 2,5-di-tert-butyl-4-hydroxybenzylphosphonate, acylaminophenols, e.g. 4-hydroxylauric anilide, esters of beta-(3,5-di-tert-butyl-4-hydroxyphenyl)propionic acid, of beta-(5-tert-butyl-4-hydroxy-3-methylphenyl)propionic acid, of beta-(3,5-dicyclohexyl-4-hydroxyphenyl)propionic acid, esters of 3,5-di-tert-butyl-4-hydroxyphenylacetic acid with mono- or polyhydric alcohols, amides of β-(3,5-di-tert-butyl-4-hydroxyphenyl)propionic acid, e.g. N,N′-bis(3,5-di-tert-butyl-4-hydroxyphenyl-propionyl)hexamethylenediamine, vitamin E (tocopherol), and derivatives, and also D,L-ascorbic acid. Examples of an amount that can be used of the antioxidants is from 0.01 to 10 parts by weight, advantageously from 0.1 to 10 parts by weight, and in particular from 0.1 to 5 parts by weight, based on 100 parts by weight of PVC.

### UV Absorbers and Light Stabilizers

Examples of these are 2-(2′-hydroxyphenyl)benzotriazoles, e.g. 2-(2′-hydroxy-5′-methylphenyl)benzotriazole, 2-hydroxybenzophenones, esters of optionally substituted benzoic acids, e.g. 4-tert-butyl-phenyl salicylate, phenyl salicylate, acrylates, nickel compounds, oxalamides, e.g. 4,4′-dioctyloxyoxanilide, 2,2′-dioctyloxy-5,5′-di-tert-butyloxanilide, 2-(2-hydroxyphenyl)-1,3,5-triazines, e.g. 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, sterically hindered amines based on tetramethylpiperidine and, respectively, tetramethylpiperazinone, or tetramethylmorpholinone, e.g. bis(2,2,6,6-tetramethylpiperidin-4-yl) sebacate, bis(2,2,6,6-tetramethylpiperidin-4-yl) succinate, and also benzoxazinones, such as 1,4-bisbenzoxazinonylbenzene.

### Optical Brighteners

Examples of these are bisbenzene(1,4)oxazoles, phenylcoumarins, and bisstyrylbiphenyls, e.g. 4-methyl-7-diethylaminocoumarin, 3-phenyl-7-(4-methyl-6-butoxybenzoxazole)coumarin, 4,4′-bis(benzoxazol-2-yl)stilbene, and 1,4-bis(benzoxazol-2-yl)naphthalene. Preference is given to solutions of optical brighteners in a plasticizer, such as DOP.

### Antistatic Agents

Antistatic agents are divided into nonionic (a), anionic (b), cationic (c), and amphoteric (d) classes. Among (a) are fatty acid ethoxylates, fatty acid esters, ethoxylated fatty alkylamines, fatty acid diethanolamides, and ethoxylated phenols and alcohols, and also monofatty acid esters of polyglycols. Among (b) are the fatty alkanesulfonates of alkali metals and the alkali metal salts of bis(fatty alcohol) esters of phosphoric acid. Among (c) are quaternary fatty alkylammonium salts, and among (d) are fatty alkyl betaines and fatty alkylimidazoline betaines. Individual preferred compounds are lauric diethanolamide, myristyldiethanolamine, Na octadecylsulfonate, and Na bisoctadecyl phosphate.

### Pigments

Pigments are another suitable constituent of the stabilizer system of the invention. The person skilled in the art is aware of suitable substances. Examples of inorganic pigments are TiO₂, zirconium-oxide-based pigments, BaSO₄, zinc oxide (zinc white), and lithopones (zinc sulfide/barium sulfate), carbon black, carbon-black-titanium-dioxide mixtures, iron oxide pigments, Sb₂O₃, (Ti,Ba,Sb)O₂, Cr₂O₃, spinelles, such as cobalt blue and cobalt green, Cd(S,Se), ultramarine blue. Examples of organic pigments are azo pigments, phthalocyanine pigments, quinacridone pigments, perylene pigments, diketopyrrolopyrrole pigments, and anthraquinone pigments. Preference is given to TiO₂, also in micronized form. “Handbook of PVC Formulating”, E. J. Wickson, John Wiley & Sons, New York, 1993 gives a definition and further descriptions.

### Biocides

Biocides that may be mentioned are: isothiazolin-3-one derivatives, such as 2-n-octyl-4-isothiazolin-3-one (OIT) and 4,5-dichloro-2-n-octyl-4-isothiazolin-3-one (DCOIT), Ag—Zn zeolite, N-trichloromethylthio-4-cyclohexene-1,2-dicarboximide, 2,3,5,6-tetrachloro-4-(methylsulfonyl)pyridine, 10,10′-oxybisphenoxarsine (OBPA), quaternary ammonium and phosphonium salts, 3-iodo-2-propynyl butylcarbamate (IPBC), methyl benzimidazole-2-carbamate, 2,4,4′-trichloro-2′-hydroxydiphenyl ether, zinc bis-2-pyridinethiolate N-oxide (zinc pyrithione), and 1,2-benzisothiazolin-3-one, N-butylbenzisothiazolin-3-one, and also 2-(4-thiazolyl)benzimidazole (thiabendazole).

### Fillers

Fillers that may be mentioned are: calcium carbonate, dolomite, calcium sulfate, talc, kaolin, mica, feldspar, nepheline, syenite, wollastonite, barium sulfate, heavy spar, aluminum hydroxide, magnesium hydroxide, carbon black, and graphite.

### Blowing Agents

Examples of blowing agents are organic azo and hydrazo compounds, tetrazoles, oxazines, isatinic anhydride, N-methylisatinic anhydride, and also soda and sodium bicarbonate. Preference is given to azodicarbonamide and sodium bicarbonate, and also to mixtures of these. Very particular preference is given to isatinic anhydride or N-methylisatinic anhydride, specifically in flexible PVC or semirigid PVC.

### Lubricants

A stabilizer system of the invention can also comprise lubricants. Examples of lubricants that can be used are: montan waxes, fatty acid esters, PE waxes and PP waxes, amide waxes, chloroparaffins, glycerol esters or alkaline-earth-metal soaps, and also fatty ketones, and combinations thereof, as listed in the patent EP 0.259.783 A1.

A stabilizer system of the invention can comprise an amount of up to about 70% by weight, in particular up to about 40% by weight, of the lubricants described.

### Plasticizers

Organic plasticizers are also suitable additives for the stabilizer system of the present invention. Examples of organic plasticizers that can be used are those from the following groups:

(i) phthalic esters, preferred examples being di-2-ethylhexyl, diisononyl, and diisodecyl phthalate, which are also known by the familiar abbreviations DOP (dioctyl phthalate, di-2-ethylhexyl phthalate), DINP (diisononyl phthalate), and DIDP (diisodecyl phthalate),
(ii) esters of aliphatic dicarboxylic acids, in particular esters of adipic, azelaic, and sebacic acid, preference being given to di-2-ethylhexyl adipate and diisooctyl adipate,
(iii) trimellitic esters, such as tri-2-ethylhexyl trimellitate, triisodecyl trimellitate (mixture), triisotridecyl trimellitate, triisooctyl trimellitate (mixture), and also tri-C₆-C₈-alkyl, tri-C₆-C₁₀-alkyl, tri-C₇-C₉-alkyl, and tri-C₉-C₁₁-alkyl trimellitates; familiar abbreviations are TOTM (tri-octyl trimellitate, tri-2-ethylhexyl trimellitate), TIDTM (triisodecyl trimellitate), and TITDTM (triisotridecyl trimellitate),
(iv) epoxy plasticizers; these are mainly epoxidized unsaturated fatty acids, e.g. epoxidized soybean oil,
(v) polymeric plasticizers: the most familiar starting materials for producing these are dicarboxylic acids such as adipic, phthalic, azelaic, and sebacic acid, and diols, such as 1,2-propanediol, 1,3-butanediol, 1,4-butanediol, 1,6-hexanediol, neopentyl glycol, and diethylene glycol, (see ADMEX® grades from Velsicol Corp. and PX-811 from Asahi Denka),
(vi) phosphoric esters: a definition of these esters can be found on pages 408-412 in chapter 5.9.5 of “TASCHENBUCH der Kunststoffadditive” [Plastics additives handbook]. Examples of these phosphoric esters are tributyl phosphate, tri-2-ethylbutyl phosphate, tri-2-ethylhexyl phosphate, trichloroethyl phosphate, 2-ethylhexyl diphenyl phosphate, cresyl diphenyl phosphate, resorcinol bisdiphenyl phosphate, triphenyl phosphate, tricresyl phosphate, and trixylenyl phosphate; preference is given to tri-2-ethylhexyl phosphate and to Reofos® 50 and 95 (see Ciba Spezialitätenchemie),
(vii) chlorinated hydrocarbons (paraffins),
(viii) hydrocarbons,
(ix) monoesters, e.g. butyl oleate, phenoxyethyl oleate, tetrahydrofurfuryl oleate, and alkylsulfonic esters,
(x) glycol esters, e.g. diglycol benzoates,
(xi) citric esters, e.g. tributyl citrate and tributyl acetylcitrate, as described in the patent WO 02/05206,
(xii) perhydrophthalic, -isophthalic, and -terephthalic esters, and also perhydrogenated glycol and diglycol benzoates; preference is given to perhydrogenated diisononyl phthalate (Hexamoll® DINCH-producer: BASF), as described in the patents DE 197.56.913 A1, DE 199.27.977 A1, DE 199.27.978 A1, and DE 199.27.979 A1.
(xiii) Castor-oil-based plasticizers (Soft-N-Safe®, producer: DANISCO),
(xiv) ketone-ethylene-ester terpolymers: Elvaloy® KEE, (Elvaloy® 741, Elvaloy® 742, producer: DuPont).

A definition of these plasticizers and examples of the same are given in pages 412-415 of chapter 5.9.6 of “TASCHENBUCH der Kunststoffadditive” [Handbook of plastics additives], R. Gächter/H. Müller, Carl Hanser Verlag, 3^{rd} edn., 1989, and also on pages 165-170 of “PVC Technology”, W. V. Titow, 4^{th}. edn., Elsevier Publ., 1984. Mixtures of various plasticizers may be used. An example of an amount that can be present of the plasticizers is up to about 99.5% by weight, in particular up to about 30% by weight, up to about 20% by weight, or up to about 10% by weight. For the purposes of one preferred embodiment of the present invention, the lower limit for these plasticizers as constituents of the stabilizer systems of the invention is about 0.1% by weight or more, for example about 0.5% by weight, 1% by weight, 2% by weight, or 5% by weight.

### Flame Retardants and Smoke Suppressants

Preferred flame retardants that can be used in flexible PVC are in particular: aluminum hydroxide, magnesium hydroxide, and oligomeric or polymeric phosphoric esters of phenol. Very particular preference is given to nanoclay-based flame retardants (organomodified clay; see Beyer, G. Journal of Fire Sciences, 2007, 25, 65-78). Smoke suppressants preferably used are inorganic substances based on zinc oxide or on tin oxide, or in the form of zinc (hydroxo)stannate, ammonium molybdate, zinc molybdate, and zinc borate, or magnesium zinc complex oxides of the formula (Mg,Zn)O (WO 2008/023249).

A stabilizer system of the invention can comprise an amount of up to about 70% by weight, in particular up to about 50% by weight, of the flame retardants described.

Definitions and examples of further additives, such as impact modifiers and processing aids, gelling agents, biocides, metal deactivators, antifogging agents, and also compatibilizers, are described in “Handbuch der Kunststoffadditive” [Handbook of plastics additives], R. Gächter/H. Müller, Carl Hanser Verlag, 3^{rd} edn., 1989, and also 4^{th} edn. 2001, and in “Handbook of Polyvinyl Chloride Formulating” E. J. Wickson, J. Wiley & Sons, 1993, also in “Plastics Additives” G. Pritchard, Chapman & Hall, London, 1st Ed., 1998. Impact modifiers are also described in detail in “Impact Modifiers for PVC”, J. T. Lutz/D. L. Dunkelberger, John Wiley & Sons, 1992.

The invention further provides compositions which comprise a polymer containing halogen, and comprise a stabilizer system of the invention.

In said compositions, components (A)+(B), (A)+(C), and (A)+(B)+(C) are to be used, advantageously in the following concentration ranges, to achieve stabilization in the polymer containing halogen:
preferred: (A) from 0.01 to 30 parts by weight
   (B) from 0.001 to 10 parts by weight
   (C) from 0.01 to 10 parts by weight
particularly preferred: (A) from 0.05 to 15 parts by weight
   (B) from 0.01 to 5.0 parts by weight
   (C) from 0.01 to 5.0 parts by weight
very particularly preferred: (A) from 0.1 to 10 parts by weight
   (B) from 0.01 to 3.0 parts by weight
   (C) from 0.01 to 3.0 parts by weight
      based on 100 parts by weight of polymer containing halogen.

It is moreover preferable that the amount used of the compounds of the formula (A) is from 0.01 to 3.0 phr, preferably from 0.05 to 1.5 phr, and particularly from 0.1 to 1.0 phr.

The composition of the invention can also, of course, comprise further compounds which have been mentioned above as constituents of the stabilizer system of the invention.

The present application therefore also provides a composition which also comprises at least one compound from the following classes of substance: the zeolites, hydrotalcites, dawsonites, and calcium carbonatohydroxodialuminates; catena-μ-2,2′,2″-nitrilotrisethanolperchlorato(-triflato) inner complexes of sodium or of lithium or, respectively, perchlorates (triflates) of lithium or of sodium, respectively in dissolved form or on a carrier; the calcium or zinc salts of fatty acid (calcium soaps or zinc soaps); polyols and sugar alcohols and/or 1,4-dihydropyridine derivatives (DHP); linear or cyclic β-diketones and, respectively, β-ketoesters, and the calcium, magnesium, or zinc salts of these; phosphorous esters (phosphites) and sterically hindered amines; glycidyl compounds and epoxidized fatty acid esters; antioxidants, UV absorbers, and optical brighteners; pigments and biocides; fillers and blowing agents; lubricants and plasticizers; flame retardants and smoke suppressants; impact modifiers and processing aids.

Examples of the polymers to be stabilized, containing halogen, are chlorine-containing polymers, in particular, with very particular preference, those of vinyl chloride, and also those of vinylidene chloride, vinyl resins containing vinyl chloride units in the structure thereof, e.g. copolymers of vinyl chloride and vinyl ester of aliphatic acids, in particular vinyl acetate, copolymers of vinyl chloride with esters of acrylic and methacrylic acid, and with acrylonitrile, copolymers of vinyl chloride with diene compounds and unsaturated dicarboxylic acids, or anhydrides of these, e.g. copolymers of vinyl chloride with diethyl maleate, diethyl fumarate, or maleic anhydride, postchlorinated polymers and copolymers of vinyl chloride, copolymers of vinyl chloride and of vinylidene chloride with unsaturated aldehydes, ketones, and other compounds, e.g. acrolein, crotonaldehyde, vinyl methyl ketone, vinyl methyl ether, vinyl isobutyl ether, and the like; polymers of vinylidene chloride and copolymers of the same with vinyl chloride and with other polymerizable compounds; polymers of vinyl chloroacetate and of dichlorodivinyl ether; chlorinated polymers of vinyl acetate, chlorinated polymers of esters of acrylic acid and of alpha-substituted acrylic acid; polymers of chlorinated styrenes, e.g. dichlorostyrne; chlororubbers; chlorinated polymers of ethylene; polymers and postchlorinated polymers of chlorobutadiene and copolymers of these with vinyl chloride, chlorinated natural and chlorinated synthetic rubbers, and also mixtures involving only the abovementioned polymers or also involving other polymerizable compounds. For the purposes of this invention, the term PVC also includes copolymers of vinyl chloride with polymerizable compounds, such as acrylonitrile, vinyl acetate, or ABS, and these can be suspension, bulk or emulsion polymers.

Preference is given to a PVC homopolymer, which can also be in a combination with polyacrylates or with polymethacrylates.

It is also possible to use graft polymers of PVC with EVA, ABS, and MBS, or else graft polymers of PVC with PMMA. Other preferred substrates are mixtures of the abovementioned homo- and copolymers, in particular vinyl chloride homopolymers, with other thermoplastic or/and elastomeric polymers, in particular blends with ABS, MBS, NBR, SAN, EVA, CPE, MBAS, PMA, PMMA, EPDM, and with polylactones, in particular from the following group: ABS, NBR, NAR, SAN, and EVA. The abbreviations used for the copolymers are familiar to the person skilled in the art and have the following meanings ABS acrylonitrile-butadiene-styrene; SAN styrene-acrylonitrile; NBR acrylonitrile-butadiene; NAR acrylonitrile-acrylate; EVA ethylene-vinyl acetate. It is also possible in particular to use styrene-acrylonitrile copolymers based on acrylate (ASA). In this context, preference is given, as component, to polymer compositions which comprise, as components (i) and (ii), a mixture of from 25 to 75% by weight of PVC and from 75 to 25% by weight of the above-mentioned copolymers. A particularly important component is compositions made of (i) 100 parts by weight of PVC and (ii) from 0 to 300 parts by weight of ABS and/or SAN-modified ABS, and from 0 to 80 parts by weight of the following copolymers: NBR, NAR, and/or EVA, but in particular EVA.

For the purposes of this invention, other materials that can be stabilized are in particular recyclates of chlorine-containing polymers, where these are the polymers described in more detail above, which have been degraded by processing, use, or storage. PVC recyclate is particularly preferred. Another use of the stabilizer combinations of the invention is based on providing antistatic properties to the finished item made of rigid or flexible PVC. This method permits reduced use of expensive antistatic agents. Flexible PVC or semirigid PVC is preferred for this application.

The invention further provides articles, such as consumer items (consumer articles), which comprise a composition of the invention and the polymer containing halogen.

Preference is also given to the use of consumer items which feature a particularly fine foam structure. This applies to rigid, flexible, and semirigid PVC. This aspect is particularly important for wallpapers and floorcoverings made of flexible PVC. Heavy metal compounds, such as Zn stabilizers or Sn stabilizers, are normally required as kicker for achieving a fine foam. Surprisingly, it has been found that TEAP inner complexes exert a kicker effect on isatinic anhydride or on N-methylisatinic anhydride, and this ensures achievement of a fine foam structure.

It is also surprising that the electrical resistance properties of a consumer item comprising TEA inner complexes as one component are dramatically improved; this proves to be particularly advantageous in the production of cables and of insulators, and in applications in the semiconductor sector.

These items (mainly cables), to the extent that they have a zinc-free stabilizer system, also perform better in underwater tests, because the formulations comprise no zinc soaps and processing does not therefore produce any zinc chloride which, after migration to the surface of the plastic, impairs electrical properties.

In zinc-sensitive applications, mainly in the flexible PVC sector (e.g. foils, roof sheeting), where these demand addition of biocides, it is moreover possible to add zinc-containing fungicides, an approach which in other situations is subjected to severe restrictions due to the use of calcium-zinc stabilizers.

The compounds that can be used concomitantly, and also the polymers containing halogen, are well known to the person skilled in the art and are described in detail in “HANDBUCH DER KUNSTOFFADDITIVE” [Handbook of plastics additives], R. Gächter/H. Müller, Carl Hanser Verlag, 3^{rd} edn., 1989 and 4^{th} edn. 2001, in DE 197.41.778 A1 and EP 0.967.245 A1, expressly incorporated herein by way of reference.

The stabilizer system of the invention is particularly suitable not only for polymer compositions containing halogen which are non-plasticized or plasticizer-free or in essence plasticizer-free compositions but also for plasticized compositions. Particular preference is given to applications in rigid PVC or semirigid PVC.

The compositions of the invention have particular suitability, in the form of rigid formulations, for hollow bodies (bottles), foils, including packaging foils (thermoforming foils), blow foils, “crashpad” foils (automobiles), and foils in the office sector, pipes, foams, profiles, including heavy-duty profiles (window frames), luminous-wall profiles, construction profiles, blister packs (including those produced by the Luvitherm process), sidings, fittings, margarine tubs, packaging for chocolates and housings for apparatus, insulators, computer housings, and constituents of household equipment, and they are also for electronics applications, in particular in the semiconductor sector. They are very particularly suitable for producing window profiles with high whiteness and surface luster.

Preferred other compositions in the form of semirigid and flexible formulations are for wire sheathing, cable insulation, decorative foils, roofing foils, foams, agricultural foils, hoses, gasket profiles, floorcoverings, wallpapers, motor-vehicle parts, flexible foils, injection moldings (blow molding), foils for the office sector, and foils for air-supported structures. Examples of the use of the compositions of the invention as plastisols are children's products (rotational molding), synthetic leather, floorcoverings, textile coatings, wallpapers, coil-coating applications, and underbody protection for motor vehicles, and examples of sinter PVC applications of the compositions of the invention are slush, slush mold, and coil-coating applications, and also, in EPVC, foils produced by the Luvitherm process. For more details in this connection, see “KUNSTSTOFFHANDBUCH PVC” [Plastics handbook: PVC], volume 2/2, W. Becker/H. Braun, 2^{nd} edn. 1985, Carl Hanser Verlag, pp. 1236-1277.

The present invention further provides the use of a stabilizer system of the invention for stabilizing a polymer containing halogen, and also the use of a composition of the invention for producing an article of the invention.

The present invention further provides a process for stabilizing a polymer containing halogen, comprising the following step:

adding a stabilizer system of the invention to the polymer containing halogen.

Experimental Section

### I. Production of Milled Sheets:

Each of the dry mixtures prepared as in Table 1.1 (R-1, and R-2), and also 2.1 (R-3, R-4, R-5, and R-6) is plastified on a Collin laboratory-roll-mill test system (COLLIN: W100E, BJ: 2005) for 5 minutes at the stated temperature (roll diameter: 110 mm, 10 rpm, friction: −10%). The resultant foils (thickness 0.3 mm) are passed onward for further testing.

### II. Method for Dehydrochlorination Tests (DHC):

DHC measures the extent of HCl elimination that occurs from PVC when it is heated. Distilled water is used to wash the hydrochloric acid eliminated, with nitrogen gas, into a collector, where the rise in conductivity is measured in microsiemens per centimeter (μS/cm). The indices used are the associated values in minutes [min], which are tabulated. The longer the time taken to achieve a certain conductivity at a particular temperature, the more heat-resistant the PVC specimen.

### Equipment: PVC Thermomat 763 (Metrohm)

The tests are carried out to DN 53381 part 1, method B: conductivity measurement.

Parameter: Starting weight of specimen: 500±0.5 mg (chopped milled sheet)
Temperature: ° C. (as stated in the examples)
Flow: 7 l/h (nitrogen 5.0)
Absorption vol.: 60 ml (demineralized water)
Evaluated values: t₁₀, t₅₀, and t₂₀₀ (conductivity 10, 50, and 200 μS/cm—stated in minutes)

### III. Method for Static Heat Test (SHT):

Test strips (15 mm×15 mm) were cut from the milled sheets produced in I. These are heated at the stated temperature in a METRASTAT IR 700 test oven (DR. STAPFER GmbH, Dusseldorf) until significant discoloration occurred. YI (Yellowness Index) is then determined to DIN 53381 using Spectro-Guide color-measurement equipment (BYK-GARDNER), and this is compared with the YI of the unheated milled sheet (zero-minute value). The results are tabulated. The smaller the YI at a given juncture, the better the color performance.

### EXAMPLE 1

### Flexible PVC, Cable Formulation

The following dry mixes were produced (Table 1.1)—starting weight in parts by weight:

TABLE 1.1
Formulations

| Components | (R-1) | (R-2) |
|---|---|---|
| PVC (Vinnolit S4170), K value = 70 | 100 | 100 |
| Plasticizer ¹⁾ (DINP) | 50 | 50 |
| Chalk ²⁾ (Polcarb 50 SV) | 50 | 50 |
| Antioxidant ³⁾ (BPA) | 0.43 | 0.43 |
| Zinc stearate ⁴⁾ | — | 1.0 |
| DMAU ⁵⁾ (B2) | 0.4 | — |
| TEAP 50 ⁶⁾ | 0.32 | — |
| Calcium magnesium dioxide ⁷⁾ (A3) | 2.57 | — |
| Sorbacid 911 ⁸⁾ | — | 2.57 |
| Total amount of stabilizer | 3.72 | 4.0 |

¹⁾ Diisononyl phthalate, ex BASF
²⁾ ex IMERYS
³⁾ Bisphenol A, ex ALDRICH
⁴⁾ ex ALDRICH
⁵⁾ 6-Amino-1,3-dimethyluracil, ex ALDRICH
⁶⁾ Catena-μ-2,2′,2″-nitrilotrisethanolperchloratosodium (50% active substance, in-house product)
⁷⁾ CeM-iX_115, ex BENE_FIT Systems GmbH & Co. KG, Hirschau, DE
⁸⁾ ex SÜD-CHEMIE (corresponds to Alcamizer 1)

Formulation (R-1) is inventive (zinc-free), since it comprises (A3)+(B2), and the comparison (R-2) is a non-inventive zinc-based stabilizer.

The DHC values for formulations (R-1) and (R-2) (Table 1.2) are as follows:

TABLE 1.2
DHC values (200° C.) as in II, milled sheets: 190° C. as in I

| Conductivity | (R-1) | (R-2) |
|---|---|---|
| [μS/cm] | [min] | [min] |
| 10 | 148 | 97 |
| 50 | 176 | 116 |
| 200 | 244 | 147 |

When (R-1) is compared with (R-2), a significant improvement can be seen in comparison with the non-inventive zinc-containing formulation (R-2) (changed to higher minute values), i.e. thermal stability has been markedly improved.

The results of the SHT on formulations (R-1) and (R-2) were as follows (Table 1.3):

TABLE 1.3
SHT (190° C.) as in III

| Time [min] | (R-1) [YI] | (R-2) [YI] |
|---|---|---|
| 3 | 23.5 | 25.0 |
| 6 | 23.4 | 26.5 |
| 9 | 23.5 | 27.0 |
| 12 | 23.7 | 27.6 |
| 15 | 24.0 | 28.1 |
| 18 | 24.1 | 28.2 |
| 21 | 24.4 | 28.7 |
| 24 | 24.7 | 29.7 |
| 27 | 25.1 | 30.1 |
| 30 | 25.2 | 30.6 |
| 33 | 25.5 | 31.4 |
| 36 | 26.0 | 32.1 |
| 39 | 26.4 | 33.1 |
| 42 | 26.9 | 33.6 |
| 45 | 27.6 | 34.9 |
| 48 | 28.3 | 36.0 |
| 51 | 29.0 | 36.4 |
| 54 | 30.0 | 37.2 |
| 57 | 31.1 | 37.5 |
| 60 | 31.7 | 39.6 |

As can be seen, when the combination of the invention (R-1) is compared with the non-inventive zinc-containing formulation (R-2) it exhibits improved color values in respect of initial color IC (up to 20 min.), color retention CR (up to 40 min.) and long-term stability LTS (up to 60 min.). This means that the effectiveness of the formulation (R-1) of the invention is significantly superior to that of the non-inventive zinc-containing formulation (R-2), although the amount of stabilizer in (R-1), 3.72 parts, is markedly smaller than the 4.0 parts in (R-2).

### EXAMPLE 2

### Rigid PVC, Window Formulation

The following dry mixes were produced (Table 2.1):

TABLE 2.1
Formulations

| Components | (R-3) | (R-4) | (R-5) | (R-6) |
|---|---|---|---|---|
| PVC (Vinnolit S3268) | 94 | 94 | 94 | 94 |
| K value = 68 | | | | |
| PVC ⁹⁾ (Vinnolit K 707) | 12 | 12 | 12 | 12 |
| Chalk (Omyalite 95T) | 6 | 6 | 6 | 6 |
| Titanium dioxide (Kronos 2220) | 4 | 4 | 4 | 4 |
| Lubricant ¹⁰⁾ (LOXIOL G60) | 0.6 | 0.6 | 0.6 | 0.6 |
| Lubricant ¹¹⁾ (LOXIOL G22) | 0.1 | 0.1 | 0.1 | 0.1 |
| Lubricant ¹²⁾ (Licowax WE 4 P) | 0.2 | 0.2 | 0.2 | 0.2 |
| Lubricant ¹³⁾ (Licowax PE 520) | 0.2 | 0.2 | 0.2 | 0.2 |
| Irganox 1010 ¹⁴⁾ | 0.15 | 0.15 | 0.15 | 0.15 |
| DMAU ⁵⁾ (B2) | 0.4 | — | — | — |
| TEAP 50 ⁶⁾ | 0.32 | — | — | — |
| THEIC ¹⁵⁾ (B1) | 0.3 | 0.31 | 0.31 | 0.31 |
| Calcium magnesium dioxide ⁷⁾ (A3) | 1.6 | — | 0.82 | 0.62 |
| Alcamizer 1 ¹⁶⁾ (C) | — | 0.82 | — | 0.20 |
| Calcium acetylacetonate ¹⁷⁾ | — | 0.3 | 0.3 | 0.3 |
| Zinc laurate ¹⁸⁾ | — | 0.75 | 0.75 | 0.75 |
| Calcium stearate ¹⁹⁾ | 0.6 | 0.68 | 0.68 | 0.68 |

⁹⁾ with impact modification based on polyacrylate (PA) (PVC:PA = 1:1)
^{10), 11)} ex COGNIS-OLEOCHEMICALS
^{12), 13)} ex CLARIANT
¹⁴⁾ ex CIBA SPEZIALITÄTENCHEMIE
¹⁵⁾ Trishydroxyethyl isocyanurate, ex ALDRICH
¹⁶⁾ ex KYOWA CHEMICAL
¹⁷⁾ ex MCC Chemiehandel, Hamburg
^{18), 19)} ex PETER GREVEN Fettchemie

Formulation (R-3) is a zinc-free formulation of the invention—since it comprises (A3)+(B1)+(B2). Formulations (R-5) and (R-6) are likewise formulations of the invention, but are zinc-containing formulations—since they comprise (A3)+(B1) and, respectively (A3)+(B1)+(C). The non-inventive comparison (R-4) is likewise a zinc-containing formulation. The constitution of (R-4) corresponds to that of a commercially available calcium-zinc stabilizer.

The DHC values of formulations (R-3) to (R-6) are as follows (Table 2.2):

TABLE 2.2
DHC values (200° C.) as in II, milled sheets: 195° C. as in I

| Conductivity | (R-3) | (R-4) | (R-5) | (R-6) |
|---|---|---|---|---|
| [μS/cm] | [min] | [min] | [min] | [min] |
| 10 | 75 | 36 | 47 | 49 |
| 50 | 97 | 40 | 66 | 62 |
| 200 | 119 | 50 | 80 | 74 |

As can be seen, when the zinc-containing formulations (R-5) and (R-6) of the invention are compared with comparison (R-4), which likewise is a zinc-containing formulation, they exhibit a significant improvement in respect of the values for 10, 50, and 200 μS/cm. The zinc-free formulation (R-3) of the invention must be assessed as having excellent effectiveness.

The result of the SHT on formulations (R-3) to (R-6) was as follows (Table 2.3):

TABLE 2.3
SHT (190° C.) as in III

| Time [min] | (R-3) [YI] | (R-4) [YI] | (R-5) [YI] | (R-6) [YI] |
|---|---|---|---|---|
| 0 | 0.5 | 2.4 | 1.6 | 1.1 |
| 3 | 0.5 | 3.6 | 1.6 | 1.5 |
| 6 | 0.5 | 4.0 | 2.1 | 1.6 |
| 9 | 0.5 | 4.3 | 1.9 | 2.1 |
| 12 | 0.4 | 4.6 | 1.8 | 1.9 |
| 15 | 0.8 | 5.2 | 2.5 | 2.5 |
| 18 | 0.9 | 6.4 | 2.7 | 2.7 |
| 21 | 1.1 | 7.3 | 3.8 | 3.4 |
| 24 | 1.5 | 9.1 | 4.0 | 3.7 |
| 27 | 1.9 | 10.4 | 4.9 | 4.3 |
| 30 | 2.4 | 12.1 | 6.5 | 5.1 |
| 33 | 3.3 | 13.7 | 8.7 | 5.8 |
| 36 | 4.3 | 16.8 | 11.6 | 6.9 |
| 39 | 5.3 | 18.3 | 14.8 | 7.9 |
| 42 | 6.4 | 20.2 | 18.3 | 9.3 |
| 45 | 7.7 | 22.7 | 23.2 | 10.9 |
| 48 | 8.8 | 24.7 | 26.7 | 13.6 |
| 51 | 10 | 27.4 | 29.1 | 16.8 |
| 54 | 11.2 | 31.2 | 32.1 | 20.5 |
| 57 | 12.6 | 33.0 | 34.0 | 23.5 |
| 60 | 13.9 | 32.9 | 35.3 | 27.5 |

As can be seen, when the zinc-containing formulations (R-5) and (R-6) of the invention are compared with the comparison (R-4), which is likewise a zinc-containing formulation, they exhibit a significant improvement in IC, CR, and LTS (lower YI values), and this could be achieved by the complete or partial replacement of Alcamizer 1 by calcium magnesium-dioxide (using the same weight).

Just as in Example 1, the zinc-free formulation (R-3) of the invention has excellent effectiveness.

What is claimed is:

1. A stabilizer system for polymers containing halogen, comprising
an alkaline earth metal double carbonate of the formula (A)
(M¹O)_{m*}(M²O)_{n-m*}(CO₂)_{o*}(H₂O)ₚ (A)
where
M¹ and M²=various alkaline earth metals;
m=from 0.9 to 1.1;
n=from 1.9 to 2.1 and p=from 0 to 2.1; or n=from 3.9 to 4.1, and p=from 0 to 4.1;
o=from 0 to 1.1
and at least one of the compounds selected from the group consisting of (B) and (C), where
(B) is at least one nitrogen-containing organic compound selected from the group consisting of (B1) and (B2), where (B1) is a tert-alkanolamine and (B2) is an enaminone or a urea, and
(C) is an alkaline earth metal aluminohydroxocarbonate of the formula (C)
(M₁₋ₓZnₓ)_{y}Al₂(OH)_{4+2y}CO_{3*}zH₂O (C)
where M=magnesium or/and calcium; x=from 0 to 0.5; y=from 2 to 8, and z=from 0 to 12.

2. The stabilizer system as claimed in claim 1, wherein the alkaline earth metal double carbonate (A) is a calcined huntite of the formula (A1)
(CaO)_{m*}(MgO)_{n-m*}(CO₂)ₒ (A1)
where m=from 0.9 to 1.1; n=from 3.9 to 4.1, and o=from 0 to 1.1.

3. The stabilizer system as claimed in claim 1, wherein the alkaline earth metal double carbonate (A) is a calcined dolomite of the formula (A2)
(CaO)_{m*}(MgO)_{n-m*}(CO₂)ₒ (A2)
where m=from 0.9 to 1.1; n=from 1.9 to 2.1, and o=from 0 to 1.1.

4. The stabilizer system as claimed in claim 3, wherein the calcined dolomite is a calcium magnesium dioxide of the formula CaMgO₂ (A3) or a calcium magnesium oxide carbonate of the formula MgO_{*}CaCO₃ (A4).

5. The stabilizer system as claimed in claim 1, wherein (B1) is at least one trialkanolamine, one bisalkanol fatty acid amine, or one trisalkanol isocyanurate.

6. The stabilizer system as claimed in claim 1, wherein (B2) is at least one substituted aminouracil, one aminocrotonic ester, or one substituted urea.

7. The stabilizer system as claimed in claim 1, wherein (C) is at least one magnesium aluminohydroxocarbonate or one magnesium zinc aluminohydroxocarbonate (C1), or one calcium carbonatohydroxodialuminate (C2).

8. The stabilizer system as claimed in claim 1, wherein at least one compound (A), (A1), (A2), (A3), and (A4) is present in coated form.

9. A composition comprising a polymer containing halogen and a stabilizer system as claimed in claim 1.

10. The composition as claimed in claim 9, wherein, based on 100 parts by weight of polymer containing halogen, from 0.05 to 10 parts by weight of the compound (A) and from 0.05 to 10 parts by weight of the compound (B1) or/and (B2), and/or from 0.005 to 9 parts by weight of compound (C) are present.

11. A process for stabilizing a polymer containing halogen, comprising the following step:
adding a stabilizer system as claimed in claim 1 to the polymer containing halogen.

12. A consumer article comprising a polymer containing halogen, and stabilized via a stabilizer system as claimed in claim 1.
